(19) United States
(12) Patent Application Publication
(10) Pub. No.: US 2025/0380925 A1
(43) Pub. Date: Dec. 18, 2025

(54) METHOD AND SYSTEM FOR MODELING ANATOMICAL SURFACES

(71) Applicant: St. Jude Medical, Cardiology Division, Inc., St. Paul, MN (US)

(72) Inventors: Lorina Dascal, Haifa (IL); Avi Motova, Haifa (IL); Jacob Segev, Haifa (IL); Yaron Valach, Atlit (IL)

(21) Appl. No.: 19/231,765

(22) Filed: Jun. 9, 2025

Related U.S. Application Data
(60) Provisional application No. 63/661,289, filed on Jun. 18, 2024.

(51) Int. Cl. A61B 8/06

(52) U.S. Cl. CPC A61B 8/06

(57) ABSTRACT

An electroanatomical mapping system models an anatomical (e.g., endocardial) surface bounding an anatomical volume (e.g., a heart chamber). The system receives a three-dimensional ultrasound image containing the volume, segments a blood pool/tissue boundary of the volume in the image, and outputs the segmented boundary as a model of the anatomical surface. In embodiments, segmentation includes solving a level set-based partial differential equation in three dimensions to iteratively expand from an initial boundary to a final boundary. In particular, an additive operator scheme, or other semi-implicit scheme, can be used to solve the partial differential equation, advantageously with all dimensions being solved in parallel.

### CROSS-REFERENCE TO RELATED APPLICATIONS

This application claims the benefit of U.S. provisional application No. 63/661,289, filed 18 Jun. 2024, which is hereby incorporated by reference as though fully set forth herein.

### FIELD

The present disclosure relates generally to medical procedures, such as cardiac diagnostic and therapeutic procedures, including electrophysiological mapping and cardiac ablation. In particular, the present disclosure relates to generating anatomical surface models.

### BACKGROUND

In connection with various cardiac diagnostic and therapeutic procedures, it is known to create a three-dimensional anatomical model of the heart chamber(s) being studied. Those of ordinary skill in the art will recognize that such models are often created by collecting numerous data points from the chamber(s) of interest.

It would be desirable, however, to be able to generate such three-dimensional anatomical models from medical images, such as intracardiac echocardiographic (ICE) and other ultrasound images.

### BRIEF SUMMARY

The instant disclosure provides a method of modeling an anatomical surface bounding an anatomical volume. The method includes: receiving a three-dimensional ultrasound image in an electroanatomical mapping system; receiving, via the electroanatomical mapping system, a user input identifying the anatomical volume; segmenting, via the electroanatomical mapping system, a blood pool/tissue boundary of the anatomical volume in the three-dimensional ultrasound image; and outputting a graphical representation of the segmented blood pool/tissue boundary as a three-dimensional model of the anatomical surface bounding the anatomical volume.

In embodiments of the disclosure, the step of segmenting, via the electroanatomical mapping system, the blood pool/tissue boundary of the anatomical volume in the three-dimensional ultrasound image includes: defining, via the electroanatomical mapping system, an initial blood pool/tissue boundary of the anatomical volume in the three-dimensional ultrasound image; and iteratively evolving, via the electroanatomical mapping system, the initial blood pool/tissue boundary into a final blood pool/tissue boundary.

The iterative evolution from the initial blood pool/tissue boundary to the final blood pool/tissue boundary can include iteratively expanding from the initial blood pool/tissue boundary into the final blood pool/tissue boundary. This can be achieved, in certain embodiments of the disclosure, by solving a level set-based partial differential equation in three dimensions, such as by applying an additive operator scheme. Advantageously, an additive operator scheme (or another semi-implicit numerical scheme) allows the level set-based partial differential equation to be solved in all dimensions in parallel.

The initial blood pool/tissue boundary can include a sphere centered within the anatomical volume.

The step of receiving, via the electroanatomical mapping system, the user input identifying the anatomical volume can include receiving, via the electroanatomical mapping system, the user input identifying the anatomical volume in a two-dimensional slice of the three-dimensional ultrasound image.

In certain aspects disclosed herein, the anatomical volume includes a heart chamber and the anatomical surface bounding the anatomical volume includes an endocardial surface bounding the heart chamber.

It is also contemplated that the three-dimensional ultrasound image can include a plurality of three-dimensional ultrasound images. The method can therefore also include merging the plurality of three-dimensional ultrasound images into a merged three-dimensional ultrasound image. The user input identifying the anatomical volume can likewise be received via the merged three-dimensional ultrasound image.

Also disclosed herein is an electroanatomical mapping system including a surface modeling module configured to: receive a three-dimensional ultrasound region of an anatomical volume; segment a blood pool/tissue boundary of the anatomical volume in the three-dimensional ultrasound image; and output a graphical representation of the segmented blood pool/tissue boundary as a three-dimensional model of an anatomical surface bounding the anatomical volume.

In embodiments of the disclosure, the surface modeling module is configured to segment the blood pool/tissue boundary of the anatomical volume in the three-dimensional ultrasound image by executing a series of steps including: defining an initial blood pool/tissue boundary of the anatomical volume in the three-dimensional ultrasound image; and iteratively evolving the initial blood pool/tissue boundary into a final blood pool/tissue boundary.

The electroanatomical mapping system can iteratively evolve the initial blood pool/tissue boundary into the final blood pool/tissue boundary by iteratively expanding from the initial blood pool/tissue boundary into the final blood pool tissue boundary, such as by solving a level set-based partial differential equation in three dimensions using an additive operator scheme. Advantageously, an additive operator scheme allows the partial differential equation to be solved in each of the three dimensions in parallel.

The initial blood pool/tissue boundary can be a sphere centered within the anatomical volume.

The three-dimensional ultrasound image can include a merger of a plurality of three-dimensional ultrasound images.

The present disclosure also provides a method of segmenting a blood pool/tissue boundary of an anatomical volume in a three-dimensional ultrasound image, including the steps of: receiving the three-dimensional ultrasound image in an electroanatomical mapping system, the three-dimensional ultrasound image depicting the anatomical volume; defining, via the electroanatomical mapping system, an initial blood pool/tissue boundary of the anatomical volume in the three-dimensional ultrasound image; and iteratively expanding from the initial blood pool/tissue boundary to a final blood pool/tissue boundary by solving a level set-based partial differential equation in three-dimensions using an additive operator scheme.

It is contemplated that the step of solving the level set-based partial differential equation in three-dimensions using the additive operator scheme can include solving the level set-based partial differential equation in each of the three-dimensions in parallel.

There is also provided a computer readable medium, a record carrier or a computer program product comprising instructions that, when executed, cause a computer or processor to perform any of the methods set forth herein.

The foregoing and other aspects, features, details, utilities, and advantages of the present invention will be apparent from reading the following description and claims, and from reviewing the accompanying drawings.

### BRIEF DESCRIPTION OF THE DRAWINGS

FIG. 1 is a schematic diagram of an exemplary electroanatomical mapping system.

FIG. 2 is a flowchart of representative steps that can be carried out according to aspects of the instant disclosure.

FIG. 3 depicts a representative three-dimensional ICE volumetric image.

FIG. 4 depicts a representative two-dimensional slice of the three-dimensional ICE volumetric image of FIG. 3.

FIG. 5 depicts a representative initial level set (or initial blood pool/tissue boundary).

FIGS. 6A-6C depict representative three-dimensional anatomical surface model according to aspects of the instant disclosure.

While multiple embodiments are disclosed, still other embodiments of the present disclosure will become apparent to those skilled in the art from the following detailed description, which shows and describes illustrative embodiments. Accordingly, the drawings and detailed description are to be regarded as illustrative in nature and not restrictive.

### DETAILED DESCRIPTION

The instant disclosure provides systems, apparatuses, and methods for modeling anatomical surfaces bounding anatomical volumes, such as endocardial surfaces bounding heart chambers. Reference will be made herein to the use of three-dimensional intracardiac echocardiography (ICE) volumetric images. Three-dimensional ICE volumetric images may be collected using an ICE catheter, such as Abbott Laboratories' ViewFlex™ Xtra ICE catheter (Abbott Park, Illinois). Exemplary embodiments will further be described in the context of a procedure carried out using an electroanatomical mapping system, such as the EnSite Precision™ cardiac mapping system or the Ensite™ X EP System, both also from Abbott Laboratories.

Those of ordinary skill in the art will understand, however, how to apply the teachings herein to good advantage in other contexts and/or with respect to other devices. For instance, the ordinarily-skilled artisan will appreciate that the teachings herein can be applied to other types of three-dimensional ultrasound volumetric images, including, without limitation, three-dimensional transesophageal echocardiographic (TEE) volumetric images and three-dimensional transthoracic echocardiographic (TTE) volumetric images. Likewise, the ordinarily-skilled artisan will appreciate how to extend the teachings herein to three-dimensional volumetric images of anatomical regions other than the heart.

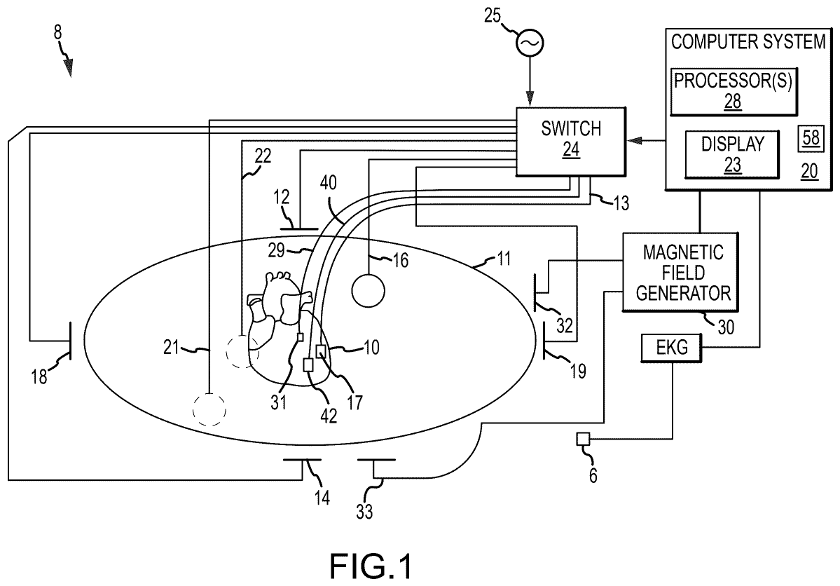

FIG. 1 shows a schematic diagram of an exemplary electroanatomical mapping system 8 for conducting cardiac electrophysiology procedures, such as electrophysiological mapping and ablation. System 8 can be used, for example, to create an anatomical model of the patient's heart 10 using one or more electrodes. System 8 can also be used to measure electrophysiology data at a plurality of points along a cardiac surface and store the measured data in association with location information for each measurement point at which the electrophysiology data was measured, for example to create a diagnostic data map of the patient's heart 10.

As one of ordinary skill in the art will recognize, system 8 determines the location, and in some aspects the orientation, of objects, typically within a three-dimensional space, and expresses those locations as position information determined relative to at least one reference. This is referred to herein as “localization.”

As depicted in FIG. 1 and described herein, system 8 can be a hybrid system that incorporates both impedance-based and magnetic field-based localization capabilities. In some embodiments, system 8 is the EnSite™ Velocity™ or EnSite Precision™ cardiac mapping system or the Ensite™ X EP System, all from Abbott Laboratories. Other electroanatomical mapping systems, however, may be used in connection with the present teachings, including, for example, the RHYTHMIA HDX™ mapping system of Boston Scientific Corporation (Marlborough, Massachusetts), the CARTO navigation and location system of Biosense Webster, Inc. (Irvine, California), the AURORA® system of Northern Digital Inc. (Waterloo, Ontario, Canada), and Stereotaxis, Inc.'s (St. Louis, Missouri) NIOBE® Magnetic Navigation System.

The localization and mapping systems described in the following patents (all of which are hereby incorporated by reference in their entireties) can also be used with the instant teachings: U.S. Pat. Nos. 6,990,370; 6,978,168; 6,947,785; 6,939,309; 6,728,562; 6,640,119; 5,983,126; and 5,697,377.

The foregoing systems, and the modalities they employ to localize a medical device, will be familiar to those of ordinary skill in the art. Insofar as the ordinarily-skilled artisan will appreciate the basic operation of such systems, therefore, they are only described herein to the extent necessary to understand the instant disclosure.

For simplicity of illustration, the patient 11 is depicted schematically as an oval. In the embodiment shown in FIG. 1, three sets of surface electrodes (e.g., patch electrodes) 12, 14, 16, 18, 19, and 22 are shown applied to a surface of the patient 11, pairwise defining three generally orthogonal axes, referred to herein as an x-axis (12, 14), a y-axis (18, 19), and a z-axis (16, 22). In other embodiments the electrodes could be positioned in other arrangements, for example multiple electrodes on a particular body surface. As a further alternative, the electrodes do not need to be on the body surface but could be positioned internally to the body. Regardless of configuration, the patient's heart 10 lies within the electric field generated by patch electrodes 12, 14, 16, 18, 19, and 22.

FIG. 1 also depicts a magnetic source 30, which is coupled to magnetic field generators. In the interest of clarity, only two magnetic field generators 32 and 33 are depicted in FIG. 1, but additional magnetic field generators (e.g., a total of six magnetic field generators, defining three generally orthogonal axes analogous to those defined by patch electrodes 12, 14, 16, 18, 19, and 22) can be used without departing from the scope of the present teachings.

An additional surface reference electrode (e.g., a “belly patch”) 21 provides a reference and/or ground electrode for the system 8. The belly patch electrode 21 may be an alternative to a fixed intra-cardiac electrode 31, described in further detail below. A magnetic patient reference sensor—anterior (“PRS-A”) can also be positioned on the patient's chest to serve as a reference, analogous to surface reference electrode 21 and/or intracardiac reference electrode 31, for magnetic field-based localization modalities.

It should also be appreciated that, in addition, the patient 11 may have most or all of the conventional electrocardiogram (“ECG” or “EKG”) system leads in place. In certain embodiments, for example, a standard set of 12 ECG leads may be utilized for sensing electrocardiograms on the patient's heart 10. This ECG information is available to the system 8 (e.g., it can be provided as input to computer system 20). Insofar as ECG leads are well understood, and for the sake of clarity in the figures, only a single lead 6 and its connection to computer 20 is illustrated in FIG. 1.

Representative catheters 13, 40 are also shown schematically in FIG. 1. In aspects of the disclosure, catheter 13 can be an ablation catheter, such as the Abbott Laboratories FlexAbility™ Ablation Catheter, Sensor Enabled™, and catheter 40 can be an intracardiac echocardiography (ICE) catheter, such as the Abbott Laboratories ViewFlex™ Xtra ICE catheter. Catheters 13, 40 each respectively include one or more sensors 17, 42 for sensing the electric fields generated by patch electrodes 12, 14, 16, 18, 19, and 22 and/or the magnetic fields generated by magnetic field generators 32, 33.

In some embodiments, an optional fixed reference electrode 31 (e.g., attached to a wall of the heart 10) is shown on yet another catheter 29. Often, reference electrode 31 is placed in the coronary sinus and defines the origin of a coordinate system with reference to which catheters 13, 40 can be localized by system 8.

The computer 20 may comprise, for example, a conventional general-purpose computer, a special-purpose computer, a distributed computer, or any other type of computer. The computer 20 may comprise one or more processors 28, such as a single central processing unit (“CPU”), or a plurality of processing units, commonly referred to as a parallel processing environment, which may execute instructions to practice the various aspects described herein.

Amongst other things, computer system 8 can interpret measurements by sensors 17, 42 of the magnetic and/or electrical fields generated by magnetic field generators 32, 33 and patch electrodes 12, 14, 16, 18, 19, and 22, respectively, to determine the position and orientation of catheters 13, 40 within heart 10. The term “localization” is used herein to describe the determination of the position and orientation of an object, such as catheter 13, within such fields.

Ultrasound imaging catheter 40 can be used to collect a plurality of two-dimensional images of heart 11 using any of several echographic imaging modalities, such as B-mode ultrasound and color Doppler echocardiography. These two-dimensional images can, in some embodiments of the disclosure, be assembled into a three-dimensional volumetric image of heart 11 (or other anatomic structure) using various techniques, including those disclosed in United States patent application publication Nos. 2006/0241445 and 2023/0039605 (both of which are hereby incorporated by reference as though fully set forth herein).

It is contemplated that ultrasound imaging catheter 40 may be coupled to an ultrasound console, such as Abbott Laboratories' ViewMate™ Ultrasound Console, which may in turn be coupled to system 8. Alternatively, and for purposes of the disclosure herein, ultrasound imaging catheter 40 will be described as coupled directly to system 8, such that aspects of the disclosure can be carried out on processor(s) 28 of computer 20.

The foregoing discussion of ICE imaging is general, insofar as numerous aspects of ICE imaging, including the use of ICE imaging in connection with electrophysiology procedures, are well-understood by those of ordinary skill in the art and need not be described in detail herein. See, e.g., Enriquez et al., “Use of Intracardiac Echocardiography in Interventional Cardiology,” Circulation, Vol. 137, Issue 21, pp. 2278-2294 (May 22, 2018). Thus, ICE imaging will only be described herein to the extent necessary to understand the instant disclosure.

As mentioned above, aspects of the disclosure relate to generating anatomical surface models from three-dimensional medical images. System 8 can therefore include a surface modeling module 58, which may be software based (e.g., a series of programming instructions executed on processor(s) 28 of computer 20), hardware-based (e.g., an application specific integrated circuit (ASIC)), or a combination thereof. The generation of surface models from three-dimensional medical images may minimize the need for electroanatomic mapping via the collection of data points in the region of interest, thereby reducing the need for patients to undergo further clinical mapping procedures. In other circumstances, the generated surface models from three-dimensional medical images may assist in corroborating or completing anatomical maps that have been derived from such collections of data points.

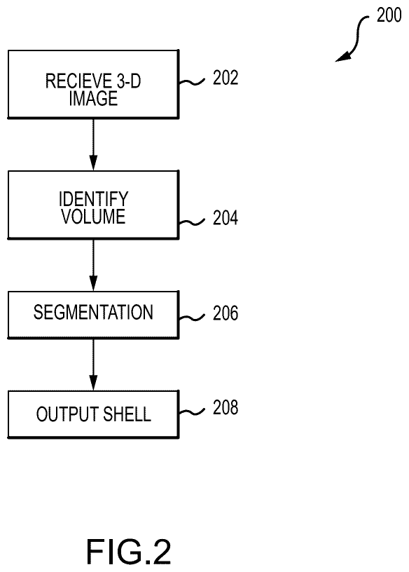

One exemplary method according to aspects of the instant disclosure will be explained with reference to the flowchart 200 of representative steps presented as FIG. 2. In some embodiments, for example, flowchart 200 may represent several exemplary steps that can be carried out by electroanatomical mapping system 8 of FIG. 1 (e.g., by processor(s) 28 and/or surface modeling module 58). It should be understood that the representative steps described below can be either hardware-or software-implemented. For the sake of explanation, the term “signal processor” is used herein to describe both hardware-and software-based implementations of the teachings herein.

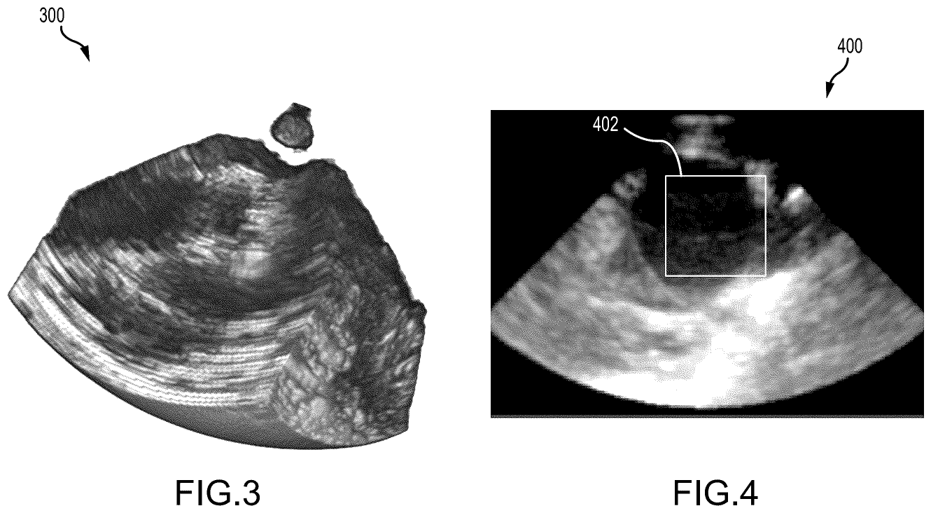

In block 202, system 8 receives a three-dimensional image (e.g., a three-dimensional ICE volumetric image) that includes a region of interest (e.g., a heart chamber) for which a surface model is desired. As mentioned briefly above, those of ordinary skill in the art will be familiar with various techniques for generating three-dimensional ICE images, and any such technique is regarded as within the scope of block 202. Similarly, just as a plurality of two-dimensional ICE image slices can be assembled into a single three-dimensional ICE volumetric image, it is contemplated that a plurality of three-dimensional ICE volumetric images can be merged or composited into merged or composite three-dimensional ICE volumetric image. As will be appreciated, the reception of one or more images in reception block 202 is the reception of data representative of those one or more images, such that processing with electroanatomical mapping system 8 (e.g., by processor(s) 28 and/or surface modeling module 58) is possible. In any case, FIG. 3 illustrates a representative three-dimensional ICE volumetric image 300.

In block 204, system 8 receives user input identifying the anatomical volume for which the bounding surface is to be modeled. The anatomical volume can be, for example, all or part of a cardiac chamber. It follows that the bounding anatomical surface being modeled can be all or part of an endocardial surface.

User input can be provided through a graphical user interface generated and output (e.g., on display 23) by system 8. For instance, system 8 can output the three-dimensional ICE volumetric image received in block 202 (e.g., volumetric image 300) to permit the user to select the anatomical volume of interest therein (e.g., by clicking on a heart chamber of interest in volumetric image 300).

In other embodiments of the disclosure, system 8 can include functionality that allows the user first to select a two-dimensional image slice (e.g., slice 400, as shown in FIG. 4) of the three-dimensional ICE volumetric image that intersects the anatomical volume of interest and next to select the anatomical volume itself (e.g., by clicking within window 402, which generally surrounds the left atrium in FIG. 4, though the techniques herein can likewise be applied to good advantage to other cardiac chambers, blood vessels, and the like).

Those of ordinary skill in the art will, of course, be familiar with various ways to identify and select regions of interest within two-and three-dimensional ICE images. As such, a detailed explanation of how the anatomical volume is selected is not essential to an understanding of the instant disclosure. Rather, for purposes of the instant disclosure, it will suffice to note that, typically, the user selects a reference point that is within the anatomical volume of interest.

In block 206, system 8 segments the blood pool/tissue boundary of the anatomical volume. Notably, and in contrast to extant systems that perform segmentation on two-dimensional image slices (and optionally assemble the segmented two-dimensional image slices into a three-dimensional volumetric image), block 206 operates directly on the three-dimensional volumetric image.

According to aspects of the disclosure, segmentation block 206 solves a level set-based evolutionary partial differential equation in three dimensions. The partial differential equation can be of form

$${φ}_{t} = \vert {∇}_{φ} \vert ( γ div ( \frac{{∇}_{φ}}{\vert {∇}_{φ} \vert} ) + {{λ}_{1} ( 1 - {μ}_{i} )}^{2} - {{λ}_{2} ( I - {μ}_{o} )}^{2} )$$

where λ₁ and λ₂ are image weight parameters that may be set to about 0.5 and about 1.0, respectively; γ is a smooth weight that may be set to about 1; μᵢ is an average of three-dimensional image intensities inside a surface; and μₒ is an average of three-dimensional image intensities outside the surface. The step interval used in the numerical scheme to solve the equation, Δt, can be about 4.0.

As those of ordinary skill in the art will appreciate, a numerical solution to the foregoing partial differential equation begins with an initial level set and then evolves (e.g., expands) that level set over a series of iterations (e.g., about six iterations in certain embodiments of the disclosure) to reach a final level set. In the context of the instant disclosure, of course, the objective is to locate the anatomical bounding surface (e.g., the endocardial surface), which represents the border between blood and tissue within the volume (e.g., heart chamber) of interest. Accordingly, for purposes of the instant disclosure, the initial level set will be referred to as the “initial blood pool/tissue boundary” and the final level set will be referred to as the “final blood pool/tissue boundary.”

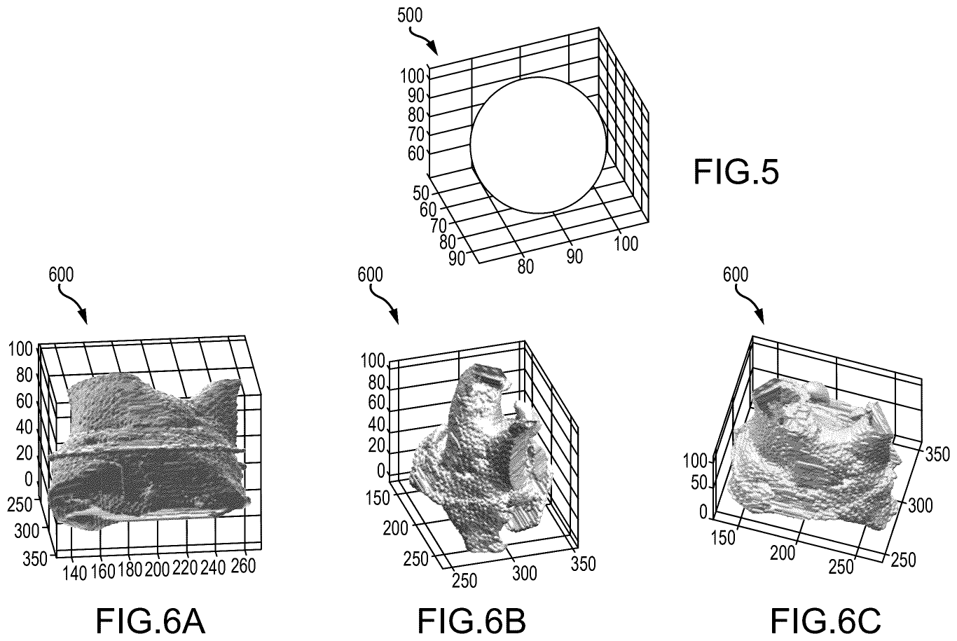

In certain aspects of the disclosure, the initial level set is a sphere positioned within the anatomical volume of interest (e.g., centered at the point selected by the user in block 204). System 8 can determine the initial radius of the initial level set sphere based on the region of interest selected by the user. FIG. 5 illustrates an initial level set sphere 500.

Because segmentation block 206 operates on a three-dimensional image, it is desirable to solve the equation above using a fast numerical scheme. Suitable numerical schemes are those that split the solution into discrete one-dimensional processes, such that the solutions in each dimension can be carried out in parallel.

For instance, in some embodiments of the disclosure, an additive operator scheme, (AOS) such as that described in Rosman et al., On Semi-Implicit Splitting Schemes for the Beltrami Color Image Filtering, Journal of Mathematical Imaging and Vision (2011) (which is hereby incorporated by reference as though fully set forth herein) is used to solve the equation above. In other embodiments of the disclosure, another semi-implicit scheme can be used to solve the equation above.

In block 208, system 8 outputs a graphical representation of the segmented (final) blood pool/tissue boundary as a three-dimensional model of the anatomical surface (e.g., endocardial surface) bounding the anatomical volume (e.g., the heart chamber). FIGS. 6A-6C show different views of a representative model 600 generated according to the foregoing teachings.

For completeness, the methods described herein may be methods that are embedded within a set of instructions that are comprised within a computer-readable medium or record carrier, or that are comprised within a computer program product. The instructions are such that, when executed by a computer or processor, such as the processor within the electroanatomical mapping system as described herein, or the processor within a surface modeling module as described herein, or a processor of a general-purpose computer system, the computer or processor causes the system or module to perform the methods described herein.

Although several embodiments have been described above with a certain degree of particularity, those skilled in the art could make numerous alterations to the disclosed embodiments without departing from the spirit or scope of this invention.

All directional references (e.g., upper, lower, upward, downward, left, right, leftward, rightward, top, bottom, above, below, vertical, horizontal, clockwise, and counterclockwise) are only used for identification purposes to aid the reader's understanding of the present invention, and do not create limitations, particularly as to the position, orientation, or use of the invention. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other.

It is intended that all matter contained in the above description or shown in the accompanying drawings shall be interpreted as illustrative only and not limiting. Changes in detail or structure may be made without departing from the spirit of the invention as defined in the appended claims.

### Numbered Clauses

1. A method of modeling an anatomical surface bounding an anatomical volume, the method comprising:
receiving a three-dimensional ultrasound image in an electroanatomical mapping system;
receiving, via the electroanatomical mapping system, a user input identifying the anatomical volume;
segmenting, via the electroanatomical mapping system, a blood pool/tissue boundary of the anatomical volume in the three-dimensional ultrasound image; and
outputting a graphical representation of the segmented blood pool/tissue boundary as a three-dimensional model of the anatomical surface bounding the anatomical volume.

2. The method according to clause 1, wherein segmenting, via the electroanatomical mapping system, the blood pool/tissue boundary of the anatomical volume in the three-dimensional ultrasound image comprises:
defining, via the electroanatomical mapping system, an initial blood pool/tissue boundary of the anatomical volume in the three-dimensional ultrasound image; and
iteratively evolving, via the electroanatomical mapping system, the initial blood pool/tissue boundary into a final blood pool/tissue boundary.

3. The method according to clause 2, wherein the initial blood pool/tissue boundary comprises a sphere centered within the anatomical volume.

4. The method according to clause 2 or clause 3, wherein iteratively evolving, via the electroanatomical mapping system, the initial blood pool/tissue boundary into the final blood pool/tissue boundary comprises iteratively expanding from the initial blood pool/tissue boundary into the final blood pool/tissue boundary.

5. The method according to one of clauses 2 to 4, wherein iteratively expanding from the initial blood pool/tissue boundary into the final blood pool/tissue boundary comprises solving a level set-based partial differential equation in three dimensions.

6. The method according to clause 5, wherein solving the level set-based partial differential equation comprises applying an additive operator scheme to solve the partial differential equation in three dimensions.

7. The method according to clause 6, wherein applying the additive operator scheme to solve the partial differential equation in three dimensions comprises applying the additive operator scheme to solve the partial differential equation in each of the three dimensions in parallel.

8. The method according to any preceding clause, wherein receiving, via the electroanatomical mapping system, the user input identifying the anatomical volume comprises receiving, via the electroanatomical mapping system, the user input identifying the anatomical volume in a two-dimensional slice of the three-dimensional ultrasound image.

9. The method according to any preceding clause, wherein the anatomical volume comprises a heart chamber and wherein the anatomical surface bounding the anatomical volume comprises an endocardial surface bounding the heart chamber.

10. The method according to any preceding clause, wherein:
the three-dimensional ultrasound image comprises a plurality of three-dimensional ultrasound images,
the method further comprises merging the plurality of three-dimensional ultrasound images into a merged three-dimensional ultrasound image, and
receiving, via the electroanatomical mapping system, the user input identifying the anatomical volume comprises receiving, via the electroanatomical mapping system, the user input identifying the anatomical volume in the merged three-dimensional ultrasound image.

11. An electroanatomical mapping system, comprising:
a surface modeling module configured to:
   receive a three-dimensional ultrasound region of an anatomical volume;
   segment a blood pool/tissue boundary of the anatomical volume in the three-dimensional ultrasound image; and
   output a graphical representation of the segmented blood pool/tissue boundary as a three-dimensional model of an anatomical surface bounding the anatomical volume.

12. The electroanatomical mapping system according to clause 11, wherein the surface modeling module is configured to segment the blood pool/tissue boundary of the anatomical volume in the three-dimensional ultrasound image by executing a series of steps comprising:
defining an initial blood pool/tissue boundary of the anatomical volume in the three-dimensional ultrasound image; and
iteratively evolving the initial blood pool/tissue boundary into a final blood pool/tissue boundary.

13. The electroanatomical mapping system according to clause 12, wherein the initial blood pool/tissue boundary comprises a sphere centered within the anatomical volume.

14. The electroanatomical mapping system according to clause 12 or clause 13, wherein iteratively evolving the initial blood pool/tissue boundary into the final blood pool/tissue boundary comprises iteratively expanding from the initial blood pool/tissue boundary into the final blood pool tissue boundary.

15. The electroanatomical mapping system according to one of clauses 12 to 14, wherein iteratively expanding from the initial blood pool/tissue boundary into the final blood pool/tissue boundary comprises solving a level set-based partial differential equation in three dimensions.

16. The electroanatomical mapping system according to clause 15, wherein solving the level set-based partial differential equation in three dimensions comprises applying an additive operator scheme to solve the partial differential equation in three dimensions.

17. The electroanatomical mapping system according to clause 16, wherein applying the additive operator scheme to solve the partial differential equation in three dimensions comprises applying the additive operator scheme to solve the partial differential equation in each of the three dimensions in parallel.

18. The electroanatomical mapping system according to one of clauses 11 to 17, wherein the three-dimensional ultrasound image comprises a merger of a plurality of three-dimensional ultrasound images.

19. A method of segmenting a blood pool/tissue boundary of an anatomical volume in a three-dimensional ultrasound image, comprising:
receiving the three-dimensional ultrasound image in an electroanatomical mapping system, the three-dimensional ultrasound image depicting the anatomical volume;
defining, via the electroanatomical mapping system, an initial blood pool/tissue boundary of the anatomical volume in the three-dimensional ultrasound image; and
iteratively expanding from the initial blood pool/tissue boundary to a final blood pool/tissue boundary by solving a level set-based partial differential equation in three-dimensions using an additive operator scheme.

20. The method according to clause 19, wherein solving the level set-based partial differential equation in three-dimensions using an additive operator scheme comprises solving the level set-based partial differential equation in each of the three-dimensions in parallel.

What is claimed is:

1. A method of modeling an anatomical surface bounding an anatomical volume, the method comprising:
receiving a three-dimensional ultrasound image in an electroanatomical mapping system;
receiving, via the electroanatomical mapping system, a user input identifying the anatomical volume;
segmenting, via the electroanatomical mapping system, a blood pool/tissue boundary of the anatomical volume in the three-dimensional ultrasound image; and
outputting a graphical representation of the segmented blood pool/tissue boundary as a three-dimensional model of the anatomical surface bounding the anatomical volume.

2. The method according to claim 1, wherein segmenting, via the electroanatomical mapping system, the blood pool/tissue boundary of the anatomical volume in the three-dimensional ultrasound image comprises:
defining, via the electroanatomical mapping system, an initial blood pool/tissue boundary of the anatomical volume in the three-dimensional ultrasound image; and
iteratively evolving, via the electroanatomical mapping system, the initial blood pool/tissue boundary into a final blood pool/tissue boundary.

3. The method according to claim 2, wherein the initial blood pool/tissue boundary comprises a sphere centered within the anatomical volume.

4. The method according to claim 2, wherein iteratively evolving, via the electroanatomical mapping system, the initial blood pool/tissue boundary into the final blood pool/tissue boundary comprises iteratively expanding from the initial blood pool/tissue boundary into the final blood pool/tissue boundary.

5. The method according to claim 3, wherein iteratively expanding from the initial blood pool/tissue boundary into the final blood pool/tissue boundary comprises solving a level set-based partial differential equation in three dimensions.

6. The method according to claim 5, wherein solving the level set-based partial differential equation comprises applying an additive operator scheme to solve the partial differential equation in three dimensions.

7. The method according to claim 6, wherein applying the additive operator scheme to solve the partial differential equation in three dimensions comprises applying the additive operator scheme to solve the partial differential equation in each of the three dimensions in parallel.

8. The method according to claim 1, wherein receiving, via the electroanatomical mapping system, the user input identifying the anatomical volume comprises receiving, via the electroanatomical mapping system, the user input identifying the anatomical volume in a two-dimensional slice of the three-dimensional ultrasound image.

9. The method according to claim 1, wherein the anatomical volume comprises a heart chamber and wherein the anatomical surface bounding the anatomical volume comprises an endocardial surface bounding the heart chamber.

10. The method according to claim 1, wherein:
the three-dimensional ultrasound image comprises a plurality of three-dimensional ultrasound images,
the method further comprises merging the plurality of three-dimensional ultrasound images into a merged three-dimensional ultrasound image, and
receiving, via the electroanatomical mapping system, the user input identifying the anatomical volume comprises receiving, via the electroanatomical mapping system, the user input identifying the anatomical volume in the merged three-dimensional ultrasound image.

11. An electroanatomical mapping system, comprising:
a surface modeling module configured to:
receive a three-dimensional ultrasound region of an anatomical volume;
segment a blood pool/tissue boundary of the anatomical volume in the three-dimensional ultrasound image; and
output a graphical representation of the segmented blood pool/tissue boundary as a three-dimensional model of an anatomical surface bounding the anatomical volume.

12. The electroanatomical mapping system according to claim 11, wherein the surface modeling module is configured to segment the blood pool/tissue boundary of the anatomical volume in the three-dimensional ultrasound image by executing a series of steps comprising:
defining an initial blood pool/tissue boundary of the anatomical volume in the three-dimensional ultrasound image; and
iteratively evolving the initial blood pool/tissue boundary into a final blood pool/tissue boundary.

13. The electroanatomical mapping system according to claim 12, wherein the initial blood pool/tissue boundary comprises a sphere centered within the anatomical volume.

14. The electroanatomical mapping system according to claim 12, wherein iteratively evolving the initial blood pool/tissue boundary into the final blood pool/tissue boundary comprises iteratively expanding from the initial blood pool/tissue boundary into the final blood pool tissue boundary.

15. The electroanatomical mapping system according to claim 14, wherein iteratively expanding from the initial blood pool/tissue boundary into the final blood pool/tissue boundary comprises solving a level set-based partial differential equation in three dimensions.

16. The electroanatomical mapping system according to claim 15, wherein solving the level set-based partial differential equation in three dimensions comprises applying an additive operator scheme to solve the partial differential equation in three dimensions.

17. The electroanatomical mapping system according to claim 16, wherein applying the additive operator scheme to solve the partial differential equation in three dimensions comprises applying the additive operator scheme to solve the partial differential equation in each of the three dimensions in parallel.

18. The electroanatomical mapping system according to claim 11, wherein the three-dimensional ultrasound image comprises a merger of a plurality of three-dimensional ultrasound images.

19. A method of segmenting a blood pool/tissue boundary of an anatomical volume in a three-dimensional ultrasound image, comprising:
receiving the three-dimensional ultrasound image in an electroanatomical mapping system, the three-dimensional ultrasound image depicting the anatomical volume;
defining, via the electroanatomical mapping system, an initial blood pool/tissue boundary of the anatomical volume in the three-dimensional ultrasound image; and
iteratively expanding from the initial blood pool/tissue boundary to a final blood pool/tissue boundary by solving a level set-based partial differential equation in three-dimensions using an additive operator scheme.

20. The method according to claim 19, wherein solving the level set-based partial differential equation in three-dimensions using an additive operator scheme comprises solving the level set-based partial differential equation in each of the three-dimensions in parallel.
